(19) United States
(12) Patent Application Publication
(10) Pub. No.: US 2012/0281403 A1
(43) Pub. Date: Nov. 8, 2012

(54) LED LAMP

(75) Inventor: Ki Tae KANG, Ansan-si (KR)

(73) Assignee: SEOUL SEMICONDUCTOR CO., LTD., Ansan-si (KR)

(21) Appl. No.: 13/463,555

(22) Filed: May 3, 2012

(30) Foreign Application Priority Data
May 6, 2011 (KR) 10-2011-0042947

(51) Int. Cl. F21V 7/00; F21V 17/10; B29C 65/48; F21V 29/00

(52) U.S. Cl. 362/237; 362/235; 156/60

(57) ABSTRACT

An exemplary embodiment of the present invention relates to a light-emitting diode (LED) lamp including a first light-emitting unit and a second light-emitting unit arranged above and below a reflector, so that light is emitted in both an upwards and downwards direction and light is reflected by the reflector, and so that the LED lamp has light distribution characteristics similar to those of conventional filament lamps.

### CROSS REFERENCE TO RELATED APPLICATION

This application claims priority from and the benefit of Korean Patent Application No. 10-2011-0042947, filed on May 6, 2011, which is hereby incorporated by reference for all purposes as if fully set forth herein.

### BACKGROUND OF THE INVENTION

1. Field of the Invention

Exemplary embodiments of the present invention relate generally to light-emitting diode (LED) lamps and, more particularly, to an LED lamp in which a first light emitting unit and a second light emitting unit are disposed above and below a reflector so that light is emitted upwards and downwards and light is reflected by the reflector, thus forming light distribution characteristics similar to that of conventional filament lamps.

2. Discussion of the Background

Lamps may be used for chandeliers, decoration lighting, etc. Lamps using conventional filament light bulbs have been widely used in these applications. However, conventional filament light bulbs may have a short lifetime, forcing users to frequently replace them with new ones.

In part to overcome the problems of conventional filament light bulbs, LED lamps were developed, which may have low power consumption and a long lifetime. However, in the case of conventional LED lamps, because of size limitations, the size of a heat sink in the LED lamp may be limited. Therefore, it may be difficult to effectively dissipate heat generated from LED lamps when emitting light.

Moreover, characteristics of LED lamps in which light emitted therefrom only travels in a forward direction may make it difficult to form light distribution patterns similar to those of convention filament light bulbs that emit light in all directions. Therefore, substituting LED lamps for filament lamps has been limited.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

Exemplary embodiments of the present invention provide an LED lamp in which a first light emitting unit and a second light emitting unit are disposed above and below a reflector so that light is emitted upwards and downwards and light is reflected by the reflector, thus forming light distribution characteristics similar to those of conventional filament lamps.

Exemplary embodiments of the present invention also provide an LED lamp which separately has a first heat sink and a second heat sink so that heat generated from the first light emitting unit and heat generated from the second light emitting unit can be independently dissipated, thus enhancing the heat dissipation efficiency of the LED lamp.

Additional features of the invention will be set forth in the description which follows, and in part will be apparent from the description, or may be learned by practice of the invention.

An exemplary embodiment of the present invention provides a light-emitting diode LED lamp, including a base unit having a connection part arranged at a first end thereof, the connection part configured to receive external power, a first light-emitting unit including a first circuit board arranged on a second end of the base unit, and at least one first LED mounted on the first circuit board, a second light-emitting unit including a second circuit board spaced apart from the first circuit board, and at least one second LED mounted on the second circuit board, the second LED facing the first LED, a reflector arranged between the first circuit board and the second circuit board, the reflector configured to reflect light emitted from the first LED and the second LED, and a transparent cover surrounding the first light-emitting unit, the second light-emitting unit, and the reflector, wherein the transparent cover is configured to protect the first light-emitting unit, the second light-emitting unit, and the reflector from exposure to an outside environment.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating an LED lamp, according to an exemplary embodiment of the present invention.

FIG. 2 is an exploded perspective view of the LED lamp of FIG. 1.

FIG. 3 is a cross-sectional view of the assembled LED lamp of FIG. 1.

FIG. 4 is a view showing paths along which rays of light are emitted from the LED lamp according to the exemplary embodiment of FIG. 1.

FIG. 5 shows a variety of shapes of a reflector used in the exemplary embodiment shown in FIG. 1.

FIG. 6a, FIG. 6b, and FIG. 6c are views showing several examples of a method of coupling of a reflector to circuit boards according to the exemplary embodiment shown in FIG. 1.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

An LED lamp 100 according to an exemplary embodiment of the present invention is characterized in that a first light emitting unit 130 and a second light emitting unit 140 are respectively disposed below and above a reflector 160 that has a first reflective surface 161a and a second reflective surface 162a, so that rays of light emitted upwards and downwards are reflected by the first reflective surface 161a and the second reflective surface 162a, thus exhibiting similar light distribution characteristics to those of the conventional filament lamps.

The LED lamp 100 includes a base unit 110, the first light emitting unit 130, the second light emitting unit 140, the reflector 160 and a transparent cover 170.

The base unit 110 forms a portion of the external appearance of the LED lamp 100, and functions to receive external power and supply the power to the first and second light emitting units 130 and 140 that include LEDs.

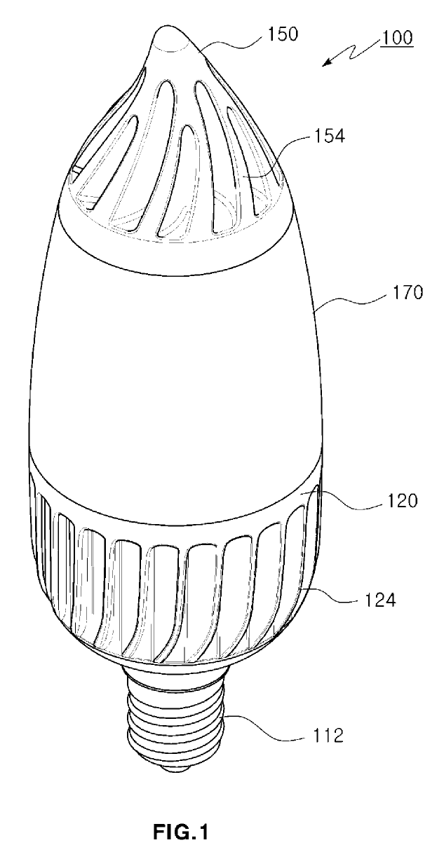

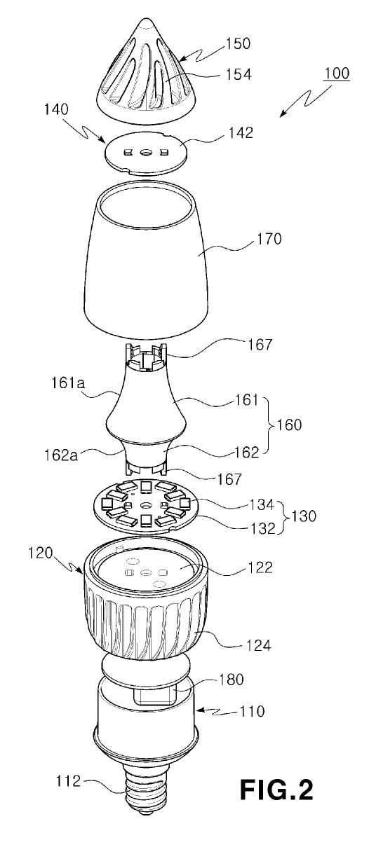

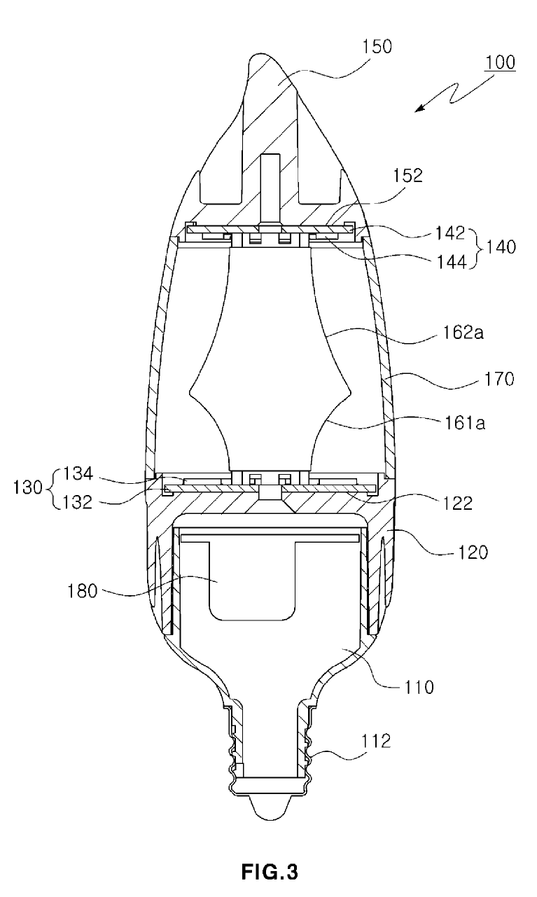

In detail, as shown in FIG. 1, FIG. 2, and FIG. 3, a connection part 112 is provided in a lower end of the base unit 110 so that external power can be applied to the base unit 110 by the connection part 112. The connection part 112 has a shape corresponding to those of typical sockets for incandescent lamps, thus enabling the LED lamp 100 to be coupled to the typical sockets. A converter 180 is installed in the base unit 110 to convert power applied from the connection part 112 into direct-current (DC) power suitable for the LEDs. A power cable (not shown) electrically connects the converter 180 to a first circuit board 132 on which a first LED 134 is mounted, so that DC power can be supplied to the first circuit board 132.

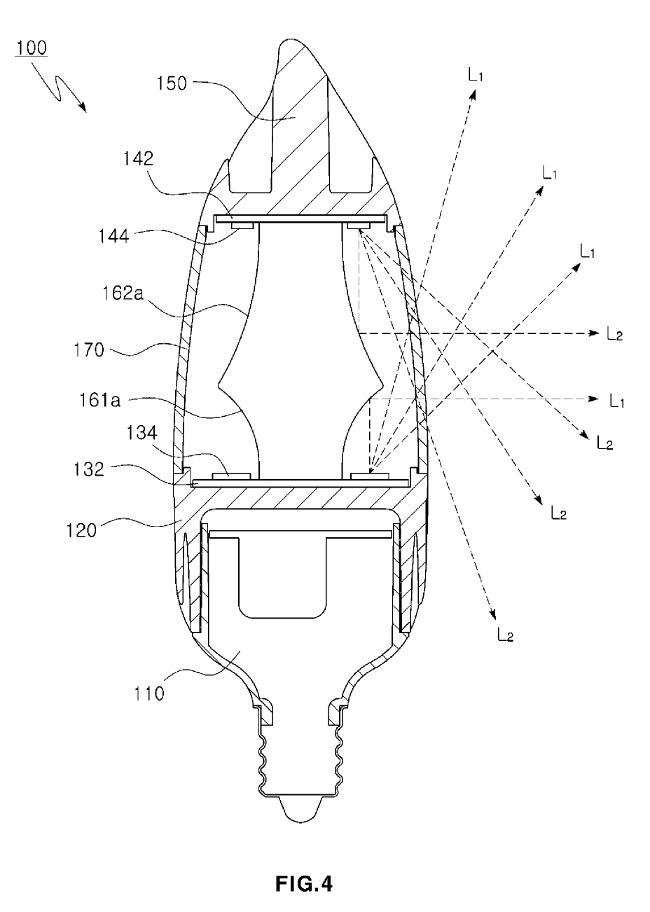

The first light emitting unit 130 is disposed above the base unit 110 and emits light upwards (based on the orientation in FIG. 1, FIG. 2, and FIG. 3) when power is applied thereto. In the first light emitting unit 130, at least one first LED 134 is mounted on the first circuit board 132 that is electrically connected to the converter 180. As shown in FIG. 4, rays of light emitted from the first LED 134 may travel straight to the transparent cover 170 and directly radiate out of the LED lamp 100 or may be reflected by the reflector 160 before radiating out of the LED lamp 100 through the transparent cover 170.

The first light emitting unit 130 having the above-mentioned construction is mounted on a first heat sink 120 so that heat generated when the first LED 134 emits light can be dissipated out of the LED lamp 100. That is, as shown in FIG. 2 and FIG. 3, the first heat sink 120 is coupled to the base unit 110, and a mounting surface 122 is formed on an upper surface of the first heat sink 120. The first circuit board 132 comes into surface contact with the mounting surface 122. Thus, heat generated from the first LED 134 may be transferred to the first heat sink 120 via the first circuit board 132 and then dissipated to the outside. Here, a plurality of heat dissipation fins 124 are provided on a circumferential outer surface of the first heat sink 120, thus further increasing the heat dissipation effect.

The first circuit board 132 may be mounted on the mounting surface 122 by an adhesive layer, such as heat dissipation tape or the like, or by different kinds of coupling methods, for example, bolt coupling, screw coupling, etc.

Although the first heat sink 120 has been illustrated as being provided as a separate element and coupled to the base unit 110 in the present exemplary embodiment, the present invention is not limited to this. For instance, the base unit 110 and the first heat sink 120 may be configured such that they are integrally formed with each other, and the mounting surface on which the first circuit board 132 is mounted is formed on the upper end of the base unit 110.

If the first heat sink 120 is integrally formed with the base unit 110, the base unit 110 may be made of a metal such as aluminum having high heat conductivity so that heat generated when the first light emitting unit 130 emits light can be effectively dissipated to the outside. Further, a plurality of heat dissipation fins may be provided on the outer surface of the base unit 110 to increase the heat dissipation surface area, thus enhancing the heat dissipation efficiency.

The second light emitting unit 140 is disposed at a position spaced apart from the first light emitting unit 130 in the vertical direction by a predetermined distance. The second light emitting unit 140 emits light in a direction opposite to the direction in which the first light emitting unit 130 emits light. In other words, light emitted from the second light emitting unit 140 radiates downwards (based on the orientation in FIG. 1, FIG. 2, and FIG. 3).

In detail, the second light emitting unit 140 includes a second circuit board 142 which is disposed at a position spaced upwards from the first circuit board 132 by a predetermined distance. At least one second LED 144 is mounted on a lower surface of the second circuit board 142. That is, the second LED 144 is mounted on the second circuit board 142 that faces the first circuit board 132 in such a way that the second LED 144 faces the first LED 134. Therefore, as shown in FIG. 4, some light L2 emitted from the second LED 144 radiates behind the first LED 134 while some light L1 emitted from the first LED 134 radiates behind the second LED 144, so that light emitted from the first and second light emitting units 130 and 140 can radiate in all directions. Thereby, the overall light distribution pattern of the LED lamp 100 of the present exemplary embodiment may be similar to that of the conventional filament lamps.

The second light emitting unit 140 is mounted on a second heat sink 150 so that heat generated when the second LED 144 emits light can be dissipated out of the LED lamp 100. In detail, as shown in FIG. 2 and FIG. 3, the second heat sink 150 is coupled to an upper end of the transparent cover 170, and a mounting surface 152 is formed on a lower surface of the second heat sink 150. The second circuit board 142 comes into surface contact with the mounting surface 152. Thus, heat generated from the second LED 144 is transferred to the second heat sink 150 via the second circuit board 142 and then dissipated to the outside. Here, a plurality of heat dissipation fins 154 are provided on a circumferential outer surface of the second heat sink 150, thus further increasing the heat dissipation effect.

As such, in the LED lamp 100 according to the present exemplary embodiment, the first light emitting unit 130 and the second light emitting unit 140 are respectively disposed below and above the reflector 160. Further, the LED lamp 100 includes the first heat sink 120 and the second heat sink 150 so that heat generated from each of the first and second light emitting units 130 and 140 can be individually dissipated. Therefore, the present exemplary embodiment may satisfactorily dissipate heat generated from the LEDs, thus making it possible to use not only a low power LED but also a high power LED as a light emitting source. Because the high power LED can be used as the light emitting source, the LED lamp 100 can emit as sufficient intensity of light as the conventional filament lamps. As a result, the LED lamp 100 may completely substitute for a conventional filament lamp.

The second circuit board 142 may also be mounted on the mounting surface 152 by an adhesive layer, such as heat dissipation tape or the like, or by different kinds of coupling methods, for example, bolt coupling, screw coupling, etc., in the same manner as the first circuit board 132.

The second circuit board 142 that supplies power to the second LED 144 is electrically connected to the first circuit board 132 or the converter 180 by a power cable (not shown).

Each of the first LED 134 and the second LED 144 may be configured in a shape of a COB (Chip on Board) wherein a plurality of LED chips are integrated on a board to form a light emitting chip, or may comprise a package type of LED device including a lead frame, or may comprise a combination of the COB type and the LED device type. Light emitted from each LED may be at least one among red, blue, and green, or may be white light.

The reflector 160 reflects some light emitted from the first and second LEDs 134 and 144 towards the transparent cover 170 in order to have desired light distribution characteristics. The reflector 160 includes a first reflective part 161 and a second reflective part 162 that respectively independently control light emitted from the first LED 134 and light emitted from second LED 144. In detail, light emitted from the first LED 134 is reflected by the first reflective surface 161a of the first reflective part 161 and bent towards the transparent cover 170, while light emitted from the second LED 144 is reflected by the second reflective surface 162a of the second reflective part 162 and bent towards the transparent cover 170.

Therefore, as shown in FIG. 4, in the LED lamp 100 according to the present exemplary embodiment, some light is emitted from the first LED 134 forwards (that is, upwards) based on the first circuit board 132 and directly travels towards the transparent cover 170, and simultaneously, some light is reflected by the first reflective surface 161a towards the transparent cover 170. In the same manner, some light is emitted from the second LED 144 forwards (that is, downwards) based on the second circuit board 142 and directly travels towards the transparent cover 170, and simultaneously, some light is reflected by the second reflective surface 162a towards the transparent cover 170.

As such, the LED lamp 100 according to the present exemplary embodiment is configured such that the first LED 134 and the second LED 144 face each other and are provided below and above the reflector 160, in other words, the reflector 160 is disposed between the first LED 134 and the second LED 144. Thus, substantially all light emitted from the first and second LEDs 134 and 144 may travel towards the transparent cover 170, thus making the overall light distribution pattern similar to that of the conventional filament lamps.

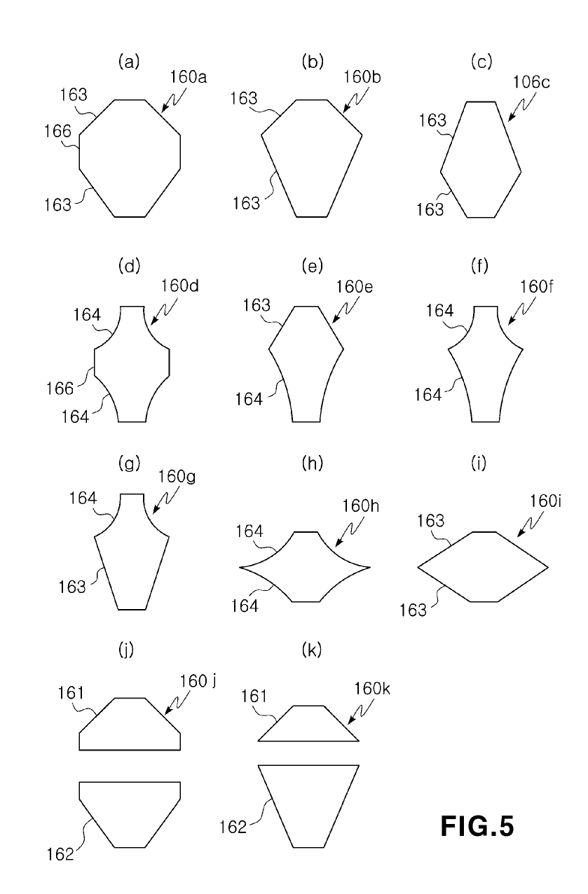

Moreover, thanks to the structure wherein the two light emitting sources are disposed above and below the reflector 160 and face each other, exemplary embodiments of the present invention can overcome the limitations of LEDs that emit light straight and can radiate light even behind the light sources, thus forming a wide-angled light distribution pattern. Meanwhile, in the reflector 160 (including various exemplary embodiments 160a, 160b, 160c, 160d, 160e, 160f, 160g, 160h, 160i, 160j, and 160k shown in FIG. 5) that reflects light emitted from the first and second LEDs 134 and 144 and sends it towards the transparent cover 170, the shapes of the first and second reflective surfaces 161a and 162a can be modified in a variety of manners to have desired light distribution patterns.

In detail, as shown in exemplary embodiment (a) of FIG. 5, the reflector 160 may be configured such that the first reflective surface 161a and the second reflective surface 162a are horizontally symmetrical to each other based on a center or lateral line parallel to the first circuit board 132. Further, the first reflective surface 161a includes an inclined portion 163 that has a longitudinal cross-sectional shape which is inclined from a lower end thereof to an upper end towards the transparent cover 170, and a vertical portion 166 that extends a predetermined length upwards from the upper end of the inclined portion 163.

As shown in exemplary embodiment (d) of FIG. 5, the reflector 160 may be configured such that the first reflective surface 161a and the second reflective surface 162a are horizontally symmetrical to each other based on a center or lateral line parallel to the first circuit board 132. Further, the first reflective surface 161a includes a curved portion 164 that has a longitudinal cross-sectional shape which is curved from a lower end thereof to an upper end towards the transparent cover 170, and a vertical portion 166 that extends a predetermined length upwards from the upper end of the curved portion 164.

As shown in exemplary embodiment (h) of FIG. 5, the reflector 160 may be configured such that the first reflective surface 161a and the second reflective surface 162a are horizontally symmetrical to each other based on a center or lateral line parallel to the first circuit board 132. Further, the first reflective surface 161a has a longitudinal cross-sectional shape that is curved from a lower end thereof to an upper end towards the transparent cover 170.

As shown in exemplary embodiment (i) of FIG. 5, the reflector 160 may be configured such that the first reflective surface 161a and the second reflective surface 162a are horizontally symmetrical to each other based on a center or lateral line parallel to the first circuit board 132. Further, the first reflective surface 161a has a linear longitudinal cross-sectional shape that is inclined from a lower end thereof to an upper end towards the transparent cover 170 at a predetermined angle.

Meanwhile, the first reflective part 161 and the second reflective part 162 may s be configured such that the lengths thereof are different from each other (as shown in exemplary embodiments (b), (c), (e), (f) or (g) of FIG. 5).

In other words, the first reflective surface 161a and the second reflective surface 162a may be configured such that they are horizontally asymmetrical to each other based on a center or lateral line parallel to the first circuit board 132, while the length of the first reflective part 161 is greater or less than that of the second reflective part 162.

As shown in exemplary embodiments (b) or (c) of FIG. 5, the reflector 160 may be configured such that the first reflective surface 161a has a linear longitudinal cross-sectional shape that is inclined from a lower end thereof to an upper end towards the transparent cover 170 at a predetermined angle. Further, the second reflective surface 162a has a linear longitudinal cross-sectional shape that is inclined from an upper end thereof to a lower end towards the transparent cover 170 at a predetermined angle.

As shown in exemplary embodiment (e) of FIG. 5, the reflector 160 may be configured such that the first reflective surface 161a has a longitudinal cross-sectional shape which is curved from a lower end thereof to an upper end towards the transparent cover 170. Further, the second reflective surface 162a has a linear longitudinal cross-sectional shape that is inclined from an upper end thereof to a lower end towards the transparent cover 170 at a predetermined angle.

As shown in exemplary embodiment (g) of FIG. 5, the reflector 160 may be configured such that the first reflective surface 161a has a linear longitudinal cross-sectional shape that is inclined from a lower end thereof to an upper end towards the transparent cover 170 at a predetermined angle. Further, the second reflective surface 162a has a longitudinal cross-sectional shape which is curved from an upper end thereof to a lower end towards the transparent cover 170.

As shown in exemplary embodiment (f) of FIG. 5, the reflector 160 may be configured such that the first reflective surface 161a has a longitudinal cross-sectional shape which is curved from a lower end thereof to an upper end towards the transparent cover 170. Further, the second reflective surface 162a has a longitudinal cross-sectional shape which is curved from an upper end thereof to a lower end towards the transparent cover 170.

Although the first reflective surface 161a and the second reflective surface 162a are shown as smooth curves or inclines in the circumferential direction in FIG. 5, they are not so limited and may be faceted or textured, for example.

Meanwhile, in the reflector 160 used in the LED lamp 100 of the present exemplary embodiment, although the first reflective part 161 that reflects light emitted from the first LED 134 may be integrally provided with the second reflective part 162 that reflects light emitted from the second LED 144, as shown in exemplary embodiments (a), (b), (c), (d), (e), (f), (g), (h), and (i) of FIG. 5, the first reflective part 161 and the second reflective part 162 may be separately formed and spaced apart from each other by a predetermined distance, as shown in exemplary embodiments (j) and (k) of FIG. 5.

The material of the reflector 160 may be resin or metal. Further, a reflective layer may be formed on an outer surface of the reflector 160, such as on an outer surface of each of the first and second reflective surfaces 161a and 162a, thus enhancing the efficiency of reflecting light emitted from the light emitting sources.

Forming the reflective layer includes applying a material such as aluminum, chrome, etc., having high light reflectivity, to each of the first and second reflective surfaces 161a and 162a to a predetermined depth. The reflective layer may be applied in various ways, for example, by deposition, anodizing, plating, etc.

The reflector 160 according to an exemplary embodiment of the present invention includes the first reflective part 161 that has the first reflective surface 161a and the second reflective part 162 that has the second reflective surface 162a. Further, the reflector 160 is disposed between the first LED 134 and the second LED 144, and separately controls the directions in which light emitted from the first LED 134 and the second LED 144 is reflected by the reflector 160. The upper end of the reflector 160 is fastened to the second circuit board 142, and the lower end thereof is fastened to the first circuit board 132.

In other words, the lower end of the first reflective part 161 is fastened to the first circuit board 132, while the upper end of the second reflective part 162 is fastened to the second circuit board 142. This structure is also applied in the case where, as shown in exemplary embodiments (j) and (k) of FIG. 5, the first reflective part 161 and the second reflective part 162 are separated and spaced apart from each other by a predetermined distance.

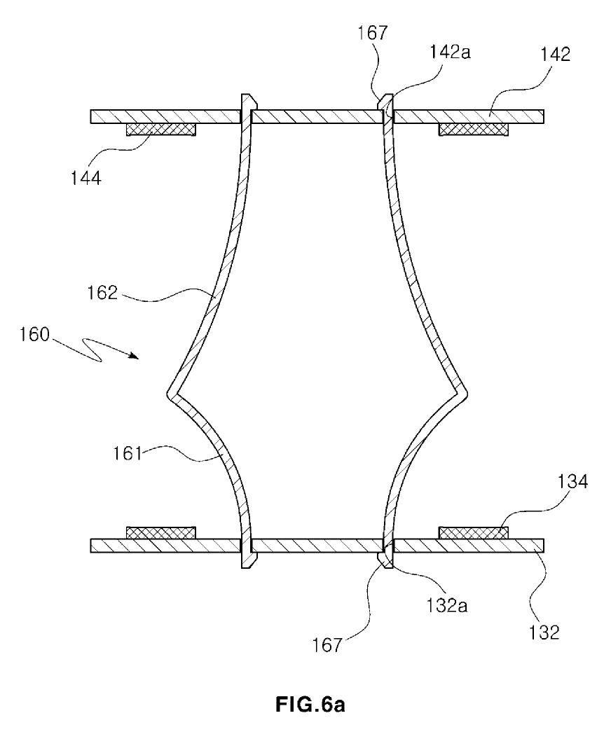

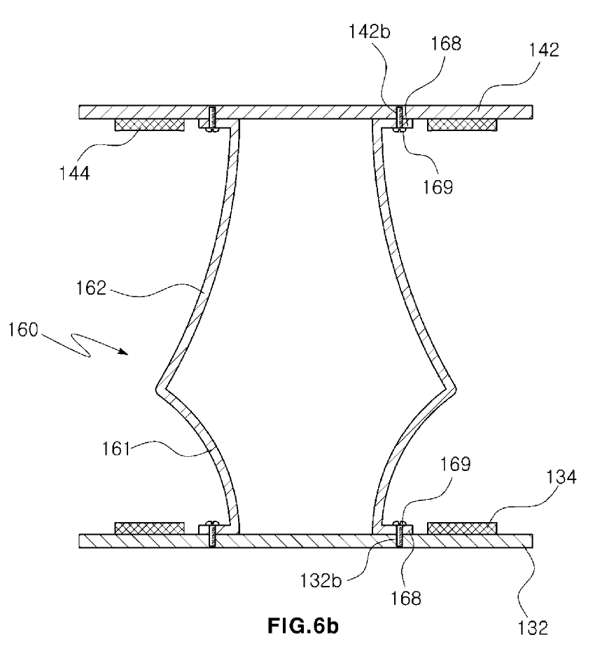

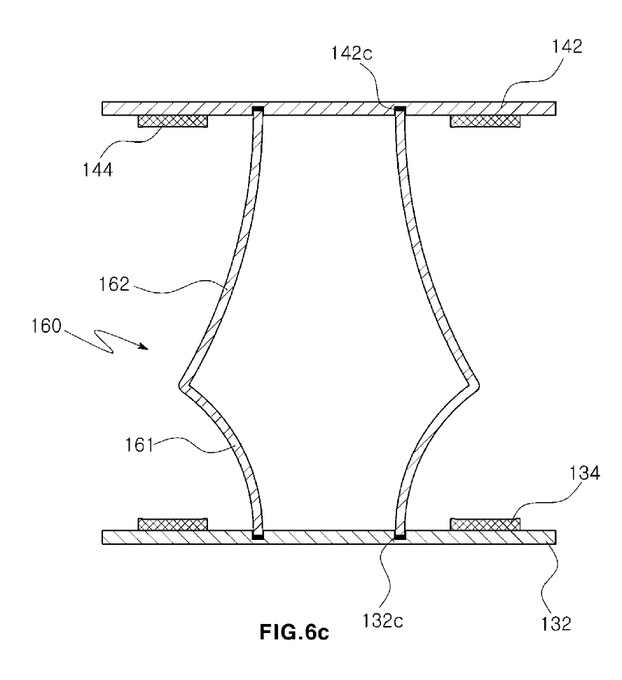

Fastening the reflector 160 to the first and second circuit boards 132 and 142 may be realized in different ways, as shown in FIG. 6a, FIG. 6b, and FIG. 6c, which include several examples, including using a connector member such as a hook, clip, pin, rivet, or adhesive.

In the exemplary embodiment shown in FIG. 6a, at least one hook 167 is provided on each of the upper and lower ends of the reflector 160. The hooks 167 are inserted into corresponding locking holes 132a and 142a, which are respectively formed through the first and second circuit boards 132 and 142, and then hooked to the first and second circuit boards 132 and 142, thus fastening the upper and lower ends of the reflector 160 to the first and second circuit boards 132 and 142, respectively.

In the exemplary embodiment shown in FIG. 6b, a coupling piece 168 is bent from each of upper and lower ends of the reflector 160 in one direction. The coupling pieces 168 are fastened to the first and second circuit boards 132 and 142 by tightening fastening members 169 both into the coupling pieces 168 and into fastening holes 132b and 142b formed in the first and second circuit boards 132 and 142.

Although each coupling piece 168 is illustrated in the present exemplary embodiment as being bent outwards from the reflector 160, the present invention is not limited to this structure. For instance, the coupling piece 168 may be bent from the reflector 160 inwards to reduce interference with light emitted from the first and second LEDs 134 and 144, thus enhancing the reflectivity of the reflector 160.

As shown in FIG. 6c, the upper and lower ends of the reflector 160 may be fastened to the first circuit board 132 and the second circuit board 142 by an insulating adhesive. Here, grooves 132c and 142c may be respectively formed in the first circuit board 132 and the second circuit board 142 so that the upper and lower ends of the reflector 160 can be inserted into the grooves 132c and 142c to predetermined depths, thus enhancing the fastening force.

In the above-described exemplary embodiments, the locking holes 132a and 142a, the fastening holes 132b and 142b, or the grooves 132c and 142c respectively formed in the first circuit board 132 and the second circuit board 142 may be disposed such that they do not overlap circuit patterns printed on the boards, in order to prevent the circuit patterns from being cut off. Furthermore, the hook 167 corresponding to each locking hole 132a and 142a may comprise a plurality of hooks 167 that are provided on each of the upper and lower ends of the reflector 160 at positions spaced apart from each other by a predetermined distance. The coupling piece 168 corresponding to each fastening hole 132b and 142b may also comprise a plurality of coupling pieces 168 that are provided on each of the upper and lower ends of the reflector 160 at positions spaced apart from each other by a predetermined distance.

The transparent cover 170 has a hollow structure that is open on opposite ends thereof. The open opposite ends, in detail, the lower and upper ends, of the transparent cover 170 are respectively coupled to the first heat sink 120 and the second heat sink 150, thus preventing the first and second light emitting units 130 and 140 and the reflector 160 from being exposed to the outside. The transparent cover 170 is transparent, allowing light emitted from the first light emitting unit 130 and the second light emitting unit 140 to radiate from the LED lamp 100 to the outside. The transparent cover 170 may comprise a light diffusion cover that can diffuse light emitted from the first and second light emitting units 130 and 140 before the light travels out of the LED lamp 100.

As described above, the LED lamp 100 according to an exemplary embodiment of the present invention is configured such that the first light emitting unit 130 and the second light emitting unit 140 are respectively disposed below and above the reflector 160 that has a predetermined length. The first LED 134 of the first light emitting unit 130 and the second LED 144 of the second light emitting unit 140 face each other so that light emitted from the first LED 134 and light emitted from the second LED 144 respectively travel upwards and downwards, that is, in the opposite directions. Further, the reflector 160 is disposed between the first light emitting unit 130 and the second light emitting unit 140 so that light can also travel sideways from the LED lamp 100. Therefore, the LED lamp 100 according to an exemplary embodiment of the present invention can overcome the limitations of LEDs that emit light in only a forward direction, and can radiate light not only forwards and rearwards but also sideways, thus forming the light distribution pattern in which light is emitted from the LED lamp 100 in all directions, in other words, forming the light distribution pattern similar to that of conventional filament lamps.

Furthermore, the LED lamp 100 is provided with the first heat sink 120 and the second heat sink 150 so that heat generated from the first light emitting unit 130 and heat generated from the second light emitting unit 140 can be independently dissipated, and the heat dissipation area can be increased. Thereby, the present invention may use not only a low power LED but also a high power LED as each light emitting source, thus making it possible for the LED lamp 100 to emit a sufficiently intensity of light for applications previously limited to only conventional filament lamps.

Although the exemplary embodiments of the present invention have been disclosed for illustrative purposes, the present invention is not limited to such a specific structure, and those skilled in the art will appreciate that various modifications, additions and substitutions are possible, without departing from the scope and spirit of the invention as disclosed in the accompanying claims and their equivalents.

In addition, although the terms first, second, etc. have been used herein, these should be understood as being used only to describe different elements. In other words, the above terms are used only for distinguishing an element from another one. For instance, a first element may be named a second element while the second element may be named a first element, if it does not depart from the scope and spirit of the present invention.

1. A light-emitting diode (LED) lamp, comprising:
a base unit comprising a connection part arranged at a first end thereof, the connection part configured to receive external power;
a first light-emitting unit comprising a first circuit board arranged on a second end of the base unit, and at least one first LED mounted on the first circuit board;
a second light-emitting unit comprising a second circuit board spaced apart from the first circuit board, and at least one second LED mounted on the second circuit board, the second LED facing the first LED;
a reflector arranged between the first circuit board and the second circuit board, the reflector configured to reflect light emitted from the first LED and the second LED; and
a transparent cover surrounding the first light-emitting unit, the second light-emitting unit, and the reflector,
wherein the transparent cover is configured to protect the first light-emitting unit, the second light-emitting unit, and the reflector from exposure to an outside environment.

2. The LED lamp of claim 1, further comprising:
a first heat sink arranged on the base unit, the first heat sink comprising a mounting surface on which the first circuit board is mounted; and
a second heat sink arranged on an end of the transparent cover, the second heat sink comprising a mounting surface on which the second circuit board is mounted,
wherein the first heat sink is spaced apart from the second heat sink, and
wherein the first heat sink and the second heat sink are configured to individually dissipate heat generated from the first light-emitting unit and the second light-emitting unit, respectively.

3. The LED lamp of claim 2, wherein at least one heat dissipation fin protrudes outwards from a circumferential surface of each of the first heat sink and the second heat sink.

4. The LED lamp of claim 1, wherein the reflector comprises:
a first reflective part comprising a first reflective surface configured to reflect light emitted from the first LED towards the transparent cover; and
a second reflective part comprising a second reflective surface configured to reflect light emitted from the second LED towards the transparent cover.

5. The LED lamp of claim 4, wherein the first reflective part and the second reflective part are symmetrical to each other based on a lateral line.

6. The LED lamp of claim 5, wherein the first reflective surface comprises a linear longitudinal cross-sectional shape that is inclined at an angle from a first end thereof to a second end towards the transparent cover.

7. The LED lamp of claim 5, wherein the first reflective surface comprises a curved longitudinal cross-sectional shape that is curved from a first end thereof to a second end towards the transparent cover.

8. The LED lamp of claim 5, wherein the first reflective surface comprises:
an inclined portion comprising a longitudinal cross-sectional shape that is inclined at an angle from a first end thereof to a second end towards the transparent cover; and
a vertical portion extending from the second end of the inclined portion.

9. The LED lamp of claim 5, wherein the first reflective surface comprises:
a curved portion comprising a longitudinal cross-sectional shape that is curved from a first end thereof to a second end towards the transparent cover; and
a vertical portion extending from the second end of the curved portion.

10. The LED lamp of claim 4, wherein the height of the longitudinal cross-sectional shape of the first reflective part is different from the height of the longitudinal cross-sectional shape of the second reflective part.

11. The LED lamp of claim 10, wherein the first reflective surface comprises a linear longitudinal cross-sectional shape that is inclined at an angle from a first end thereof to second end towards the transparent cover, and the second reflective surface comprises a linear longitudinal cross-sectional shape that is inclined at an angle from a first end thereof to second end towards the transparent cover.

12. The LED lamp of claim 10, wherein the first reflective surface comprises a curved longitudinal cross-sectional shape that is curved from a first end thereof to second end towards the transparent cover, and the second reflective surface comprises a linear longitudinal cross-sectional shape that is inclined at an angle from a first end thereof to second end towards the transparent cover.

13. The LED lamp of claim 10, wherein the first reflective surface comprises a linear longitudinal cross-sectional shape that is inclined at an angle from a first end thereof to second end towards the transparent cover, and the second reflective surface comprises a curved longitudinal cross-sectional shape that is curved from a first end thereof to second end towards the transparent cover.

14. The LED lamp of claim 10, wherein the first reflective surface comprises a curved longitudinal cross-sectional shape that is curved from a first end thereof to second end towards the transparent cover, and the second reflective surface comprises a curved longitudinal cross-sectional shape that is curved from a first end thereof to second end towards the transparent cover.

15. The LED lamp of claim 4, wherein a first end of the first reflective part is connected to the first circuit board and a first end of the second reflective part is connected to the second circuit board, and
wherein the first reflective part and the second reflective part are spaced apart from each other.

16. The LED lamp of claim 1, wherein a first end and a second end of the reflector are respectively connected to the first circuit board and the second circuit board.

17. The LED lamp of claim 16, wherein at least one connector member is arranged on each of the first end and the second end of the reflector, and the at least one connector members are respectively connected to the first circuit board and the second circuit board.

18. The LED lamp of claim 16, wherein a coupling piece bent from each of the first end and the second end of the reflector in a first direction,
wherein a coupling hole is arranged in the coupling piece, and a fastening hole is arranged in each of the first circuit board and the second circuit board, and
wherein the coupling piece is configured to be fastened to the corresponding first circuit board or the second circuit board by tightening a fastening member into the coupling hole and the fastening hole.

19. The LED lamp of claim 16, wherein the first end and the second end of the reflector are respectively connected to the first circuit board and the second circuit board by an adhesive.

20. The LED lamp of claim 17, wherein the at least one connector member comprises a hook inserted into and locked to a corresponding locking hole arranged in each of the first circuit board and the second circuit board.

21. A light-emitting diode (LED) lamp, comprising:
a first light-emitting unit comprising at least one first LED;
a second light-emitting unit comprising at least one second LED, the second LED facing the first LED; and
a reflector arranged between the first light-emitting unit and the second light-emitting unit, the reflector comprising a first reflective surface and a second reflective surface.

22. The LED lamp of claim 21, further comprising:
a base unit comprising a connection part arranged at a first end thereof, the connection part configured to receive external power;
a first circuit board arranged on a second end of the base unit, the at least one first LED mounted on the first circuit board;
a second circuit board spaced apart from the first circuit board, the at least one second LED mounted on the second circuit board; and
a transparent cover arranged around the first light-emitting unit, the second light-emitting unit, and the reflector,
wherein the first reflective surface is configured to reflect light emitted from the first LED towards the transparent cover, and the second reflective surface is configured to reflect light emitted from the second LED towards the transparent cover.
